(19) United States
(12) Patent Application Publication
(10) Pub. No.: US 2020/0044598 A1
(43) Pub. Date: Feb. 6, 2020

(54) HYBRID ELECTRIC POWER SYSTEM POWER CURVE AND PRODUCTIVITY

(71) Applicant: General Electric Company, Schenectady, NY (US)

(72) Inventors: Luiz Andre Moyses LIMA, Rio de Janeiro (BR); Baduino JUNIOR, Rio de Janeiro (BR); Thomas FRIC, Greenville, SC (US)

(21) Appl. No.: 16/055,607

(22) Filed: Aug. 6, 2018

(51) Int. Cl. H02S 10/12; G06Q 50/06; F03D 9/00; F03D 9/25; H02J 7/35; H02J 3/38

(52) U.S. Cl. CPC H02S 10/12; G06Q 50/06; F03D 9/007; H02J 3/386; H02J 7/35; H02J 3/383; F03D 9/25

(57) ABSTRACT

A method of a site evaluation for a hybrid wind/solar power generation plant, the method including generating a hybrid wind/solar power curve, the power curve including a plurality of solar power level curves, each solar power level curve including a combined wind and solar output power for at least one wind condition. Evaluating performance of the hybrid wind/solar power generation plant by analyzing the family of curves. A system for implementing the method and a non-transitory computer-readable medium are also disclosed.

### BACKGROUND

The worldwide demand for electrical energy has been increasing year by year. Most of the electrical energy demand is met by energy produced from conventional energy sources such as coal and gas. However, in recent years there has been a push for electricity generation by renewable energy resources such as solar power, wind power, etc.

A hybrid power generation plant can be a combination of wind and solar energy power modules. Wind turbine generators are regarded as environmentally friendly and relatively inexpensive alternative sources of energy that utilize wind energy to produce electrical power. Solar power generation uses photovoltaic (PV) modules to generate electricity from the sunlight. Because the intensity of wind and sunlight is not constant over time, the power output of a hybrid of wind turbine and PV modules can fluctuate throughout the day. Unfortunately, the electricity demand does not vary in synchronization with solar and wind power generation fluctuations.

The site of a wind/solar power generation plant can greatly affect the power generation capacity of the plant. What is missing from the art are techniques to quantify power production by a wind/solar power generation plant to inform the selection of an optimum site from among potential installation sites.

### BRIEF DESCRIPTION OF THE DRAWINGS

FIG. 1 illustrates a portion of a hybrid wind/solar power curve for a wind/solar power generation system in accordance with embodiments;

FIG. 2 illustrates an equivalent circuit schematic for a hybrid wind/solar power generation system model in accordance with embodiments;

FIG. 3 illustrates a wind/solar power generation plot in accordance with embodiments;

FIG. 4 illustrates a flowchart for a process to generate the hybrid wind/solar power curve of FIG. 1 in accordance with embodiments; and

FIG. 5 illustrates a system for generating the hybrid power curve of FIG. 1 in accordance with embodiments.

### DETAILED DESCRIPTION

Embodying systems and methods provide a combined wind/solar hybrid power curve that can provide a prediction on how much power could be generated at each operating point along the curve. A hybrid wind/solar system will operate under different levels of wind speed and solar irradiation.

For optimal site selection, an embodying wind/solar hybrid power curve is a useful tool in providing knowledge on expected power that can be generated at each operating point before committing to constructing the hybrid power generation plant at a particular site. A predictive hybrid power curve covering site conditions (e.g., expected solar irradiance and wind characteristics) for several sites can be produced. From these predictive power curves, a net energy production forecast can be determined and an informed site selection decision can be made.

The site-specific hybrid power curve can be useful in evaluating a site's suitability for installing a wind/solar power generation system. Also, the site-specific hybrid power curve can be used in determining specifications for the wind turbine and the solar panels at that site. It should be readily understood that embodying systems and methods can also generate power curves for an installed site. In accordance with embodiments, this power curve can be based on actual, monitored historical environmental site conditions and power generation.

Embodying power curves provide not only information on the total energy that can be generated by a hybrid wind/solar power generation plant for specific site conditions; but also the individual power contribution generated by the solar panels, and the individual power contribution generated by the wind generator. The combined total power presented in the power curve can be a function of contributions from both the wind and solar renewable energy power modules. Unlike conventional power curves, embodying power curves provide segregated values of power, which cover both wind speed and solar operating ranges.

Wind turbine generators can be provided with a factory-generated power curve based on a range of simulated transient wind conditions. Conventionally, simulated power curves can be based on various wind speed bins (e.g., in increments of 0.5 m/s), calculating for each single operating point the generated wind power, and averaging this value for the whole bin. Conventional power curves can be calculated by considering two 10-min intervals of wind speed. For every measured wind speed point within the 10 minute interval, the wind-generated power is calculated based on the wind turbine's factory specifications and other electrical parameters. The average value is presented as the delivered wind power for the particular wind speed bin.

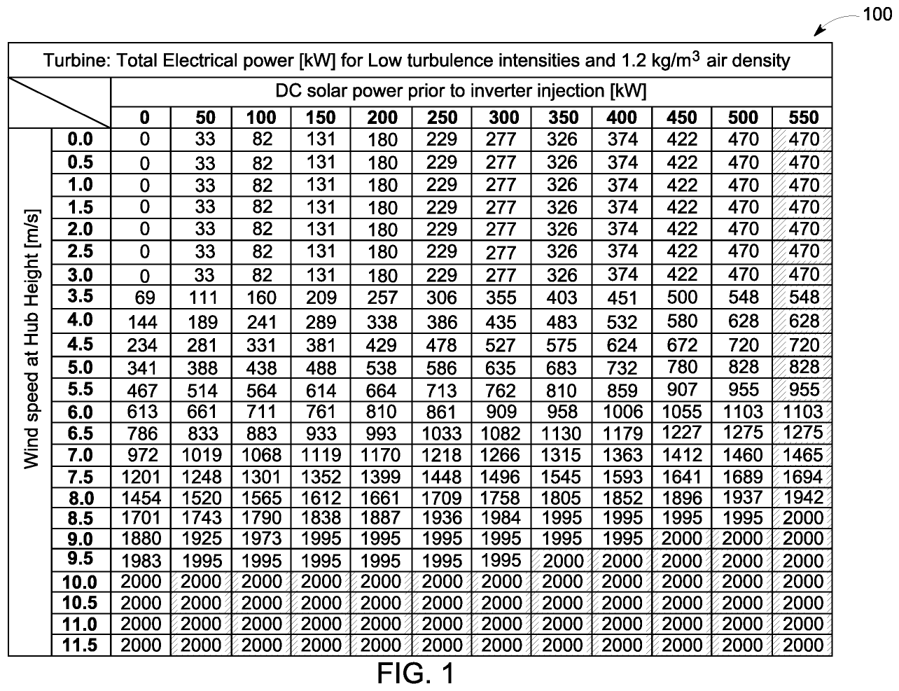

Embodying hybrid power curves take power contributions from each source (wind and solar) into consideration. Embodying power curves indicate the amount of generated power for different combinations of operating points between these two. In accordance with implementations, an embodying power curve can present a family of power curves, where each individual curve represents a different level of solar generation. FIG. 1 illustrates hybrid power curve 100 accounting for both wind and solar generated power in accordance with embodiments. For purposes of discussion, hybrid power curve 100 is truncated at a wind speed bin of 9.5 m/s.

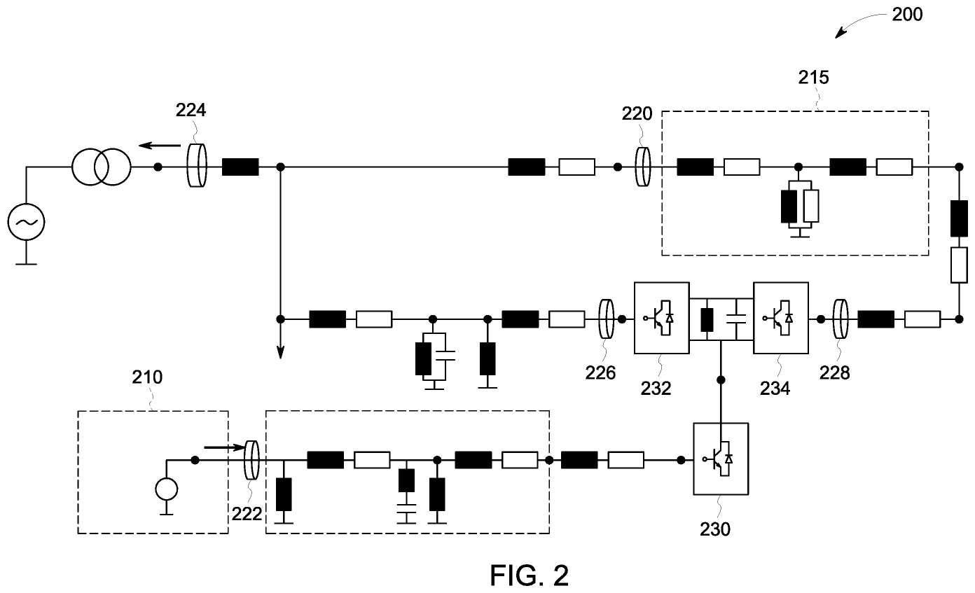

FIG. 2 illustrates an equivalent circuit schematic for hybrid wind/solar power generation system model 200 in accordance with embodiments. In accordance with some implementations, some basic assumptions regarding attributes of the model can be incorporated. It need not be mandatory to incorporate one or all of the assumptions. Exemplar assumptions can include, but are not limited to, the following:

1) All electrical parameters are known (e.g., cable resistances, filter inductances, etc.);

2) Steady-state conditions for electrical result (e.g., constant wind power, constant solar power); and

3) Each value of the power curve wind speed bin relates to a given (e.g., factory specification) value for rotor power and rotating speed. These values are dependent on wind turbulence level and air density;

The hybrid power generation system model 200 includes solar power energy module 210. Which can include one or more photovoltaic cells. The generated solar power is filtered and provided to DC-DC converter 230. A first portion of the generated solar power is provided through line-side power converter 232 to an energy grid, and optionally to auxiliary load(s) local to the hybrid generation plant.

Hybrid power generation system model 200 also includes wind turbine generator 215. The wind turbine can be a doubly fed electrical generator (DFIG), which includes features to run at speeds slightly above or below their natural synchronous speed to compensate for sudden wind speed change. A second portion of the generated solar power is provided through rotor-side power converter 234 to the rotor of wind turbine 215.

Sensors 220, 222, 224, 226, 228 are modeled as if distributed throughout the model circuit. Sensor 220 represents the wind turbine generator output power. Sensor 222 represents the solar panel output power. In some implementations, the intensity of solar irradiance exposure to the photovoltaic panels can be modeled, but the efficiency of the panels would need to be known.

Sensor 224 represents the power delivered to the power network grid by the hybrid wind/solar power generation plant. Sensor 226 represents the power output from line-side power converter 232. Sensor 228 represents the power output from rotor-side power converter 234.

In accordance with embodiments, a power curve algorithm generates power curves for each operating point of wind speed. An embodying power curve algorithm can calculate the corresponding amount of solar generation needed to be added to the wind generated power to attain a power output goal—e.g., to maximize both wind and solar, and/or to maximize rated power capacity of the combined system). The power curve algorithm can account for one or more factors including, but not limited to: current and power safety level, possible solar power reduction, and the electrical path solar generated power can follow within the circuit. The power curve algorithm repeats its process of obtaining solar and wind power contributions for all points across a time period (e.g., 10 minutes) at one wind speed operating point. These time-dependent power contributions are then averaged, so that the final representation on the power curve represents a time-averaged wind speed operating point.

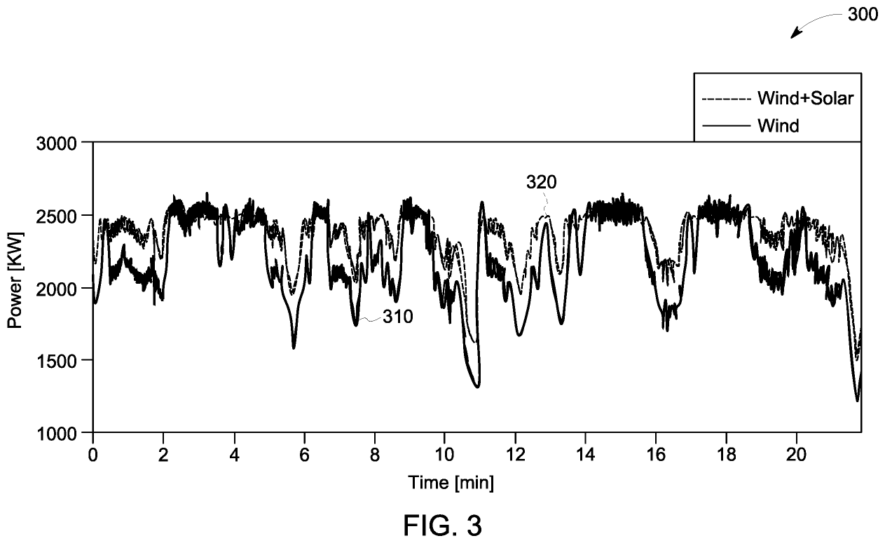

FIG. 3 illustrates power generation plot 300 representing a 22-minute time series at a typical range of wind speeds near maximum rated power in accordance with embodiments. Plot 300 represents just over two 10 minute intervals at a single wind speed bin. Wind generated power plot 310 varies over time directly with the wind turbulence. Wind/solar generated output power plot 320 similarly varies over time. The amount of solar generated power contributing to the output power plot is represented by the difference between plots 310, 320 at any instant of time. Power generation plot 300 considers a possible maximum solar panel power output of 300 kW. By calculating the difference between plots 310, 320 across a 10 minute bin, and averaging the results, an average of 187 Kw is being contributed by the solar panels to the total power delivered to the power network grid.

In accordance with embodiments, certain assumptions and conditions can be adhered to in order to provide a more accurate depiction of the potential total power (wind and solar) output based on the conditions at a potential installation site. It need not be mandatory to incorporate one or all of the assumptions and/or conditions. Exemplar assumptions and or conditions can include, but are not limited to, the following:

1) When the total combined generation of both wind and solar would exceed the nameplate capability of the wind turbines converter, wind generation is given priority and solar generation will be curtailed to remain under the nameplate limit;

2) Because both wind and solar both contribute, the wind turbine's converter capability, wind speed, and solar data inputs to the power curve must be for a corresponding time period to properly predict excess power generation above the turbine nameplate. Any excess can result in curtailment of the solar power contribution. The curtailment of the solar power contribution is more readily achieved, as curtailment of wind turbine power generation occurs over a longer time frame than a reduction in solar contribution;

3) The amount of solar power is represented by data from sensor 222, i.e., just prior to filtering the solar power injection into DC-DC converter 230. The illustrated solar family curves (FIG. 1 columns) are not based on a specific solar array size, but on the solar power generated. Therefore, when simulating the solar array, any size solar panel and/or quantity of panels can be used when specifying the actual wind/solar power generation system;

4) The wind power contribution is that which would be generated by the aero portion of the system based on the wind speed at the same point in time as the solar power input corrected for all conversion, line, and aux losses of the system;

5) The amount of solar power generated by the solar portion is that portion based on the DC solar power amount injected at the power converter at the same point in time as the wind power input—corrected for conversion, line, and curtailment (if any);

6) The calculated power curves can vary based on turbulence intensity (TI), wind shear, air density, and other factors. Accordingly, the hybrid wind/solar power curve can be a multidimensional table.

In accordance with embodiments, the results from a steady state simulation can be used as the starting values for dynamic simulations. The effect of turbulence can be modeled by adding a statistical variation to the wind. If the turbulence is modeled as a statistical phenomenon, each calculation can typically be performed multiple times with different turbulence seeds to get a representative result.

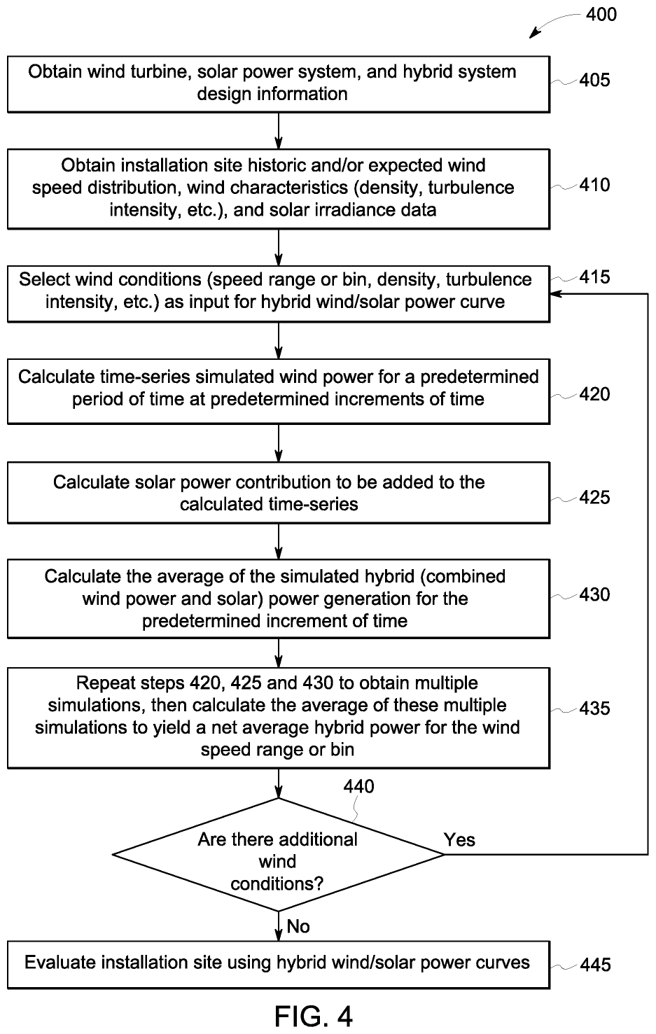

FIG. 4 illustrates process 400 to implement a hybrid power curve algorithm in accordance with embodiments. The hybrid power curve algorithm produces an installation site specific embodying hybrid wind/solar power curve, which can be used in evaluating the site's suitability. and selection of wind and solar energy module specifications. The site-specific hybrid power curve can also be used in evaluating and/or specifying the operating specifications for the wind turbine and solar panels at that site.

Wind turbine system, solar power panel, and hybrid system design information and/or specifications are obtained, step 405. Also, equivalent circuit electrical parameters for the wind/solar power generation hybrid system can be obtained. At step 410, site-specific wind pattern data (e.g., speed distribution, turbulence intensity, etc.) and solar irradiance data is obtained. This data and specifications can be located in data records stored in a data store. The data can be historic (e.g., monitored) and/or expected (e.g., forecasted conditions).

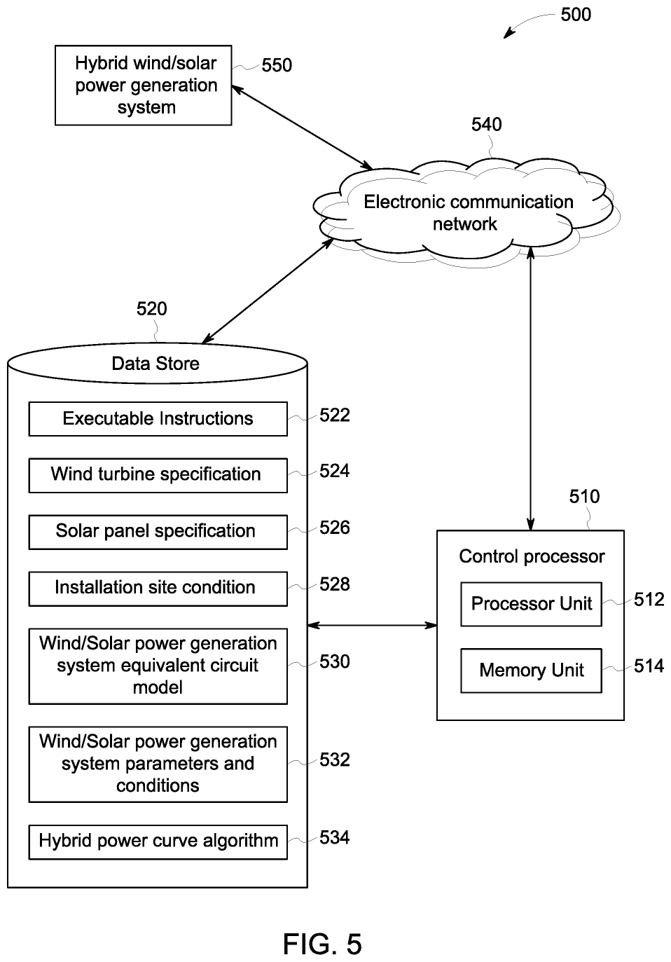

FIG. 5 illustrates a system 500 for generating a site-specific hybrid power curve in accordance with embodiments. Data store 520 can include wind turbine specification records 524, solar panel specification records 526, wind/solar power generation system equivalent circuit model 530. The site-specific wind pattern data and solar irradiance data can be included in installation site condition records 528. The site specific conditions can be historic data monitored and/or predictive data based on known environmental weather patterns and conditions for the site. The data store can also include hybrid power curve algorithm 534.

Returning to process 400, wind conditions for the hybrid wind/solar power curve is selected, step 415. These conditions can include, but are not limited to, speed range or bin, density, turbulence intensity, etc. A time-series simulation of the wind power turbine generation output for the selected operating point is calculated, step 420. The simulation calculates the wind output power for a predetermined period of time, and averages over predetermined increments of time. For example, wind generated power plot 310 can be a representative result of the simulation. The simulation can include the effect of wind/solar power generation system parameters and condition records 532.

A solar power generation contribution for the selected operating point is calculated, step 425. An average of the simulated hybrid (combined wind power and solar power contributions) power generation is calculated, step 430. The average can be calculated based on data within a time window spanning across multiple data points generated at the predetermined increments of time. In some implementations the time window can be, for example, about 10 minutes. In accordance with embodiments, the predetermined period of time (step 420) can be of sufficient duration to accommodate at least two time windows, for example, about 20 minutes or more. It should be readily understood that embodiments are not limited to a particular window of time.

The increments of solar power generation can be across a range of solar power output capacity for the solar panel(s). For example, this range can be selected to cover a higher generation efficiency portion of the solar panel operations, which can be identified from information in solar panel specification records 526. This contribution of solar power can be limited based on a specified maximum power output for the wind/solar power generation system.

In some implementations, there need not be any specified maximum power output. The solar power contribution to the hybrid power output can be expressed as the difference between the average wind output power for the operating point and the hybrid power output. In accordance with embodiments, because solar panel power generation is simpler to control, the amount of solar power contribution is selected to be reduced, rather than reducing the wind generated power contribution.

Each time increment of wind power within the time-series should have a solar power contribution (even if zero) added at the same time increment. Solar power contribution is a function of solar irradiance (possible solar power), wind power level, and the maximum power output limit of the hybrid wind/solar power plant.

In some embodiments where the simulation is stochastic in nature, steps 420, 425 and 430 can be repeated to yield additional simulated average hybrid power levels within a wind speed range or bin. The average of multiple simulations can be calculated to yield a combined net average hybrid power for the wind speed range or bin, step 435.

If a hybrid power curve for additional wind conditions is to be produced (step 440), process 400 returns to step 415 to produce another curve of the family of curves that make up the embodying hybrid wind/solar power curve. If curves for the wind speed conditions have been produced, then process 400 continues to step 445. The installation site can be evaluated, step 445. The evaluation can be performed by analyzing the embodying site-specific hybrid wind/solar power curve.

Returning to FIG. 5, system 500 can include control processor 510 in communication with data store 520. The control processor can be in direct communication with the data store, or in indirect communication across electronic communication network 540. Processor unit 512 can execute executable instructions 522, which cause the processor to perform hybrid power curve algorithm 534. Memory unit 514 can provide control processor with local cache memory.

Installation site condition records 528 can include environmental conditions obtained from environmental sensors located at a potential installation site, prior to installation of a hybrid wind/solar power generation system. In some embodiments to evaluate (or re-evaluate) a site, installation site condition records 528 can include data from actual sensors 220, 222, 224, 226, 228 located in a hybrid wind/solar power generation system 550. This hybrid power system can be in communication with the data store across electronic communication network 540.

In accordance with embodiments, embodying hybrid wind/solar power curves can be produced for existing, already installed wind/solar power generation systems. These hybrid power curves can be used in evaluating the installation site performance. The performance evaluation of an existing wind/solar power generation system can be based on such criteria as, for example, revenue generation potential, cost-of-delivery for electrical power, maintenance prediction, etc.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods disclosed herein, such as a method of generating a hybrid wind/solar power curve for installation site evaluation and selection, as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

1. A method of site evaluation for a hybrid wind/solar power generation plant, the method comprising:
generating a hybrid wind/solar power curve, the power curve including a plurality of solar power level curves, each solar power level curve including a combined wind and solar output power for at least one wind speed operating point;
evaluating performance of the hybrid wind/solar power generation plant by analyzing the family of curves;
generating the hybrid wind/solar power curve including:
obtaining wind turbine specifications and solar panel specifications for the hybrid wind/solar power generation plant;
obtaining site-specific environmental condition data;
selecting a wind condition;
calculating a wind generated power contribution for the selected wind condition;
calculating a solar power generated contribution for the selected wind condition; and
combining the wind power generated contribution and the solar power generated contribution to obtain a net power for the selected wind condition.

2. The method of claim 1, calculating the wind power generated contribution including:
calculating wind power generated contribution by applying wind turbine specifications at the selected wind speed operating point for predetermined increments of time spanning a predetermined period of time; and
averaging the calculated wind power generated contribution for a window of time encompassing a plurality of the increments of time.

3. The method of claim 2, including incorporating an effect of one or more wind/solar power generation system parameters into the calculation of the wind power generated contribution.

4. The method of claim 1, the calculation of solar power generated contribution including a maximum limit of contribution, the maximum contribution limit based on a specified maximum power output for the hybrid wind/solar power generation plant.

5. The method of claim 1, the site-specific environmental condition data including one or more of actual, monitored, or historical environmental site conditions.

6. The method of claim 1, including specifying design requirements for one of a wind turbine and a solar panel based on the hybrid wind/solar power curve.

7. The method of claim 1, the evaluating performance including analyzing the hybrid wind/solar power curve to achieve at least one of:
determining power contribution for the hybrid wind/solar power generation plant;
selecting at least one of wind energy module specifications and solar energy module specifications for the hybrid wind/solar power generation plant;
determining a revenue generation potential for the hybrid wind/solar power generation plant; and
determining a cost-of-delivery for electricity provided by the hybrid wind/solar power generation plant.

8. A non-transitory computer-readable medium having stored thereon instructions which when executed by a processor cause the processor to perform a method of site evaluation for a hybrid wind/solar power generation plant, the method comprising:
generating a hybrid wind/solar power curve, the power curve including a plurality of solar power level curves, each solar power level curve including a combined wind and solar output power for at least one wind speed operating point;
evaluating performance of the hybrid wind/solar power generation plant by analyzing the family of curves;
generating the hybrid wind/solar power curve including:
obtaining wind turbine specifications and solar panel specifications for the hybrid wind/solar power generation plant;
obtaining site-specific environmental condition data;
selecting a wind condition;
calculating a wind generated power contribution for the selected wind condition;
calculating a solar power generated contribution for the selected wind condition; and
combining the wind power generated contribution and the solar power generated contribution to obtain a net power for the selected wind condition.

9. The medium of claim 8, the executable instructions causing the processor to perform calculating the wind power generated contribution by including:
calculating wind power generated contribution by applying wind turbine specifications at the selected wind speed operating point, the calculated wind power generated contribution calculated for predetermined increments of time spanning a predetermined period of time; and
averaging the calculated wind power generated contribution for a window of time encompassing a plurality of the increments of time.

10. The medium of claim 9, the executable instructions causing the processor to perform calculating the wind power generated contribution by including incorporating an effect of one or more wind/solar power generation system parameters into the calculation of the wind power generated contribution.

11. The medium of claim 8, the executable instructions causing the processor to perform calculating solar power contribution by including a maximum limit of contribution, the maximum contribution limit based on a specified maximum power output for the hybrid wind/solar power generation plant.

12. The medium of claim 8, the executable instructions causing the processor to include in the site-specific environmental condition data including one or more of actual, monitored, or historical environmental site conditions.

13. The medium of claim 8, the executable instructions causing the processor to perform the method by including specifying design requirements for one of a wind turbine and a solar panel based on the site-specific hybrid wind/solar power curve.

14. The medium of claim 8, the executable instructions causing the processor to perform the evaluating performance by including analyzing the hybrid wind/solar power curve to achieve at least one of:
determining site-specific power generation levels for the hybrid wind/solar power generation plant;
selecting at least one of wind energy module specifications and solar energy module specifications for the hybrid wind/solar power generation plant;
determining a revenue generation potential for the hybrid wind/solar power generation plant; and
determining a cost-of-delivery for electricity provided by the hybrid wind/solar power generation plant.
